(19) United States
(12) Patent Application Publication
(10) Pub. No.: US 2008/0093288 A1
(43) Pub. Date: Apr. 24, 2008

(54) Filter Medium for a Fluid

(76) Inventors: Hartmut Harr, Stuttgart (DE); Hans Waibel, Remseck/Aldingen (DE)

Correspondence Address: COLLARD & ROE, P.C., 1077 NORTHERN BOULEVARD, ROSLYN, NY, 11576, US

(21) Appl. No.: 11/661,823

(22) PCT Filed: Aug. 27, 2005
(86) PCT No.: PCT/DE05/01510

§ 371 Date: Mar. 12, 2007

(30) Foreign Application Priority Data
Sep. 2, 2004 (DE) 102004042410.1

(51) Int. Cl. B01D 27/06; B29C 45/14

(52) U.S. Cl. 210/435; 210/493.4; 264/257

(57) ABSTRACT

The invention relates to a filter medium in the form of a wound filter with a number of adjacent tubular flow channels (5, 6) with a radial flow, which are formed from a double-layered filter web material of which one layer has a smooth embodiment and the other is corrugated. The aim of the invention is to provide the above with a simple and hence economically-produced seal, by means of which the above may repeatedly be exchangeably inserted in a filter device with a seal with little complexity. Alternatively and optionally additionally the end regions for sealing of the filter web material which forms the wound filter should permit a simplified and reliable sealing. The above is achieved by means of a material wherein felt is provided on the external circumference of the wound filter as sealing material for a radial seal within a housing. Furthermore, the amplitude of the corrugations of the corrugated layer of the filter web material in the circumferentially terminating end regions can be embodied to taper gently towards the end and are produced accordingly.

The invention relates to a filter medium for a fluid comprising a plurality of adjacent tubular flow channels according to the preamble of claim 1.

Such a filter medium is known, for example, from EP 0 900 118 B1 and WO 02/20135 A2. The fluid flow takes place in such a filter element having a honeycomb structure in such a manner that those tubular flow channels in which the fluid to be filtered flows in at one end are closed at the other end so that the fluid can flow into neighbouring channel through the circumferential walls of these channels, whose opposite end is closed in each case.

In each case, these known filters are provided with a casing of in particular non-flow-through material which externally surrounds all the flow channels and runs along the axes of these flow channels. In this case, this casing is provided with a circumferential sealing means so that this filter medium can be used exchangeably in a sealing manner, for example, as an exchangeable filter element in a flow channel of a filter device.

A filter web material wound to form a generic filter medium protrudes in a step fashion at its ends, that is at the beginning and end of the winding, over the web located thereunder or thereabove. Since the wound web material of a filter medium must be sealed radially outside and inside, such a step-shaped runout of the ends of the filter web is unfavourable for the production of the relevant seals. The web material for a wound filter is usually wound radially inwards on a strip whilst a seal is made radially outwards by a seal which surrounds the circumference of the wound filter over a partial length.

The object of the invention is to provide a filter medium, in particular in the form of a wound filter which can be produced more economically and reliably compared to the previously known prior art with regard to the measures to be provided on its outer circumference for a radial seal.

This object is achieved to an extent which already represents a considerable improvement compared with the prior art merely by one of the measures according to claims 1 or 4.

Advantageous and appropriate embodiments are the subject matter of the dependent claims as well as claim 10 which proposes a combination of the features according to claims 1 and 4 including the respectively relevant dependent claims.

The design of the filter medium according to the invention according to the entire combination of features in claim 1 is based on the general idea of providing a circumferential casing which can easily be applied and comprises at least one axial partial region of nonwoven as a radial sealing material for sealed insertion of the filter medium into a filter housing. The filter medium can hereby achieve a sufficient seal with respect to the opening edge in a simple manner for sealing abutment against the opening edge of a flow channel of a filter device by simple insertion. A felt-like material can also be used if this has sufficient elastic deformability. A casing made of nonwoven and/or felt can be permeable for the fluid to be filtered, whereby the degree of filtration must not be inferior to the remaining filtration material. Nonwoven as a sealing material particularly has the effect that the sealing material does not stick to a counter-bearing surface of a filter device. Such sticking makes it difficult to simply exchange the filter since large detaching forces are required to release the sticking and necessitates a corresponding gripping device on the filter medium for its exchange.

When nonwoven or felt is used as casing material, web-like material can be used, wherein this web material can be wound onto the core of the filter medium in multiple layers. The casing material can be firmly joined to the material of the flow channel walls located externally on the circumference of the filter medium, for example, by gluing or welding.

The general idea forming the basis of the teaching of claim 4 is to configure double-layered filter web material during production as continuous material in such a manner that periodically differently configured length sections are formed which come to lie at the beginning of winding and/or the end of winding after the filter web material has been cut to length for a specific wound filter to be produced.

This is achieved by varying the amplitudes of the corrugations in the relevant length regions of the filter web material to be produced and specifically in each case from an initial value in a region of the filter web material which should lie between these end regions of a wound filter to be produced, down to 0. If the initial and end regions of the wound filter web material are to run out continuously in a wound filter, length regions should be provided in the endless filter web material to be produced, in which the corrugation amplitudes increase from a value 0 at the centre of this differently configured length region outwardly in each case as far as the normal value between these length regions. The filter web material for a wound filter to be produced should then be cut to length at the centre of this length region with varying corrugation amplitudes.

In the embodiment according to claim 4, the circumferential casing which can merely extend over a short axial partial region can consist of an arbitrary elastic sealing material and specifically, for example, of a polyurethane foam.

For the production of a wound filter of generic filter web material, it can be advantageous to provide a merely two-layered but non-corrugated web section on the outer circumference. This can easily be achieved by a corresponding production of the filter web material whereby a corrugation-free section of corresponding length is periodically provided in the filter web material.

Endless filter web material configured according to the invention can be produced extremely simply by varying the spacing of the embossing rollers which emboss the corrugations into the one layer of the filter web material during the embossing process. The corrugation amplitudes can thus be varied arbitrarily. In each case, the embossing rollers lie in pairs in front of intermeshing tooth-like embossing profiles.

Advantageous exemplary embodiments which are explained in detail hereinafter are shown in the drawings. These exemplary embodiments relate, among others, to a wound filter of filter web material according to claim 4 as well as relevant dependent claims and a possible method of manufacture for such a filter web material.

In the drawings:

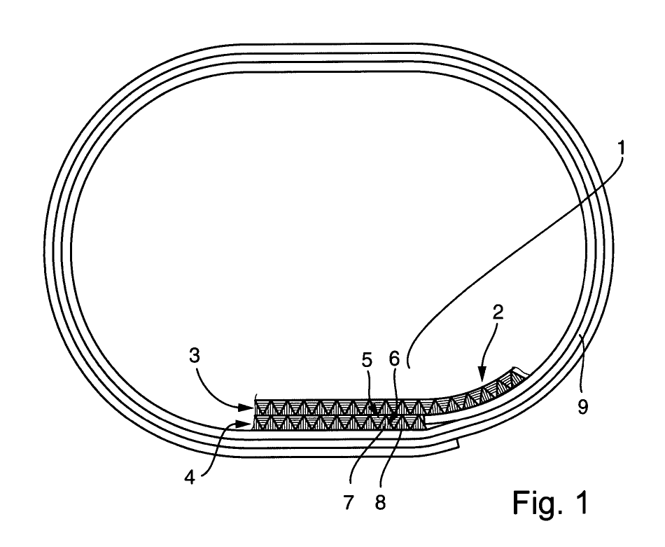

FIG. 1 is a plan view of a filter medium,

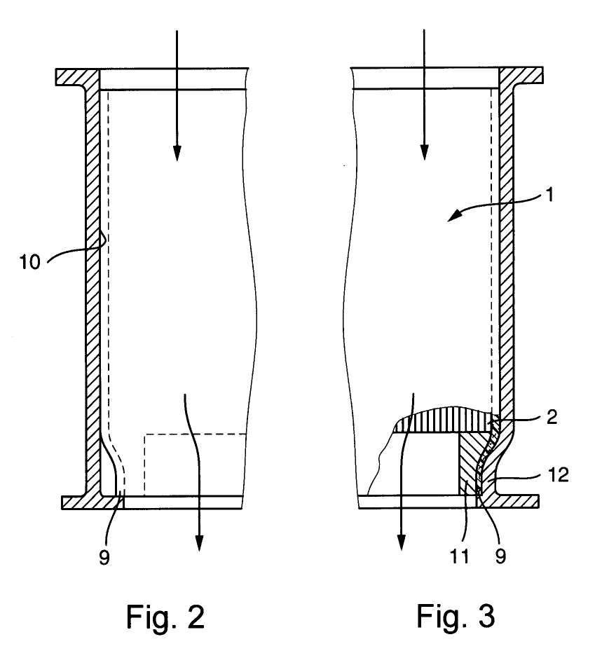

FIG. 2 is a side view of a left partial region of the filter medium according to FIG. 1 with an indicated filter housing in a first embodiment,

FIG. 3 is a side view of a right partial region of the filter medium according to FIG. 1 with an indicated filter housing in an alternative embodiment,

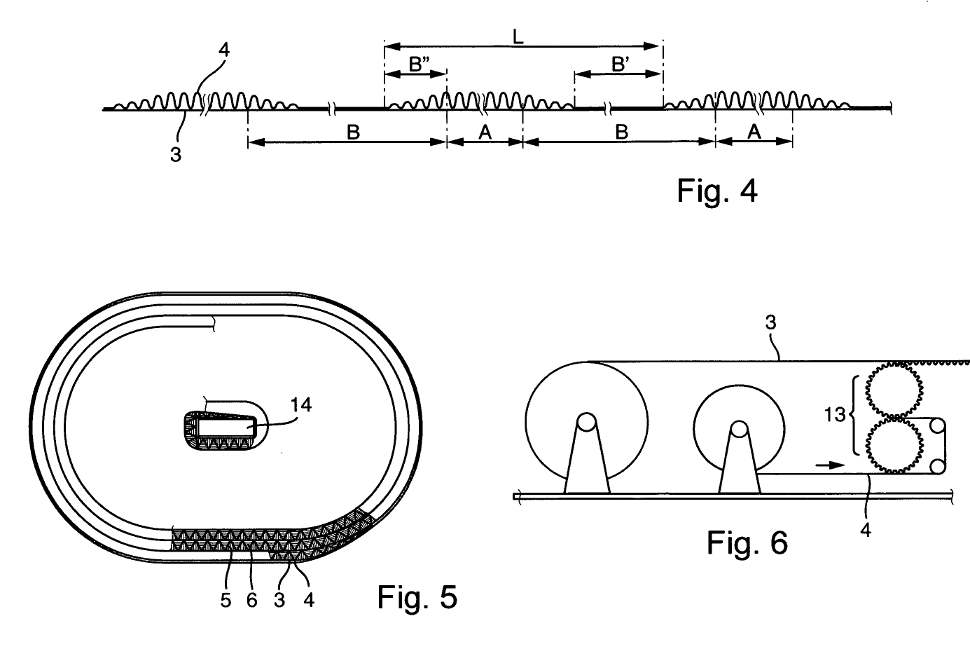

FIG. 4 is a view of a length section of an endless filter web material with differently configured, periodically repeating length sections,

FIG. 5 is a plan view of a wound filter of endless filter web material,

FIG. 6 is a device for producing a double-layered corrugated endless filter web material.

### EMBODIMENT ACCORDING TO FIG. 1-3

A filter medium is constructed of web-like sandwich material 2 wound to a core 1 to produce a so-called wound filter. This sandwich material 2 consists of a first layer of filter material 3 and a second layer of filter material 4. The first layer of filter material 4 consists of web material which is corrugated or folded in a zigzag fashion.

As a result of the zigzag shaped folded or corrugated second filter web material 4, flow channels 5, 6 for a fluid to be filtered are formed inside the sandwich material 2 as well as in combination with superposed wound filter material layers 3, 4. The fluid flows through the filter medium in the direction of the flow arrows shown in FIGS. 2 and 3.

The flow channels 5 and 6 of a sandwich material 2 are respectively alternatively sealed at one and the other end by sealing material 7 or 8. The sealing material 7 lies at the end of the flow channels 5 on the inflow side and the closure material 8 lies at the end of the flow channels 6 on the outflow side in each case. As a result, the fluid to be filtered flows into the flow channels 6 and flows out from the flow channels 5. In this situation, on its way through the core 1 of the filter medium, the fluid flows through the circumferential walls of the flow channels 5, 6 for which purpose the sandwich material 2 forming the circumferential walls is formed to be permeable as filter material.

The outer circumference of the core 1 of the filter medium is enclosed by a circumferential casing 9. This circumferential casing 9 consists of multiply wound nonwoven in the form of a web material. Both the winding layer of the circumferential casing 9 directly adjacent to the core 1 and the layers wound upon one another themselves are in each case glued or welded to the substrate on which they are lying, that is the core 1 on the one hand and the winding layers themselves on the other hand. The circumferential casing 9 can cover the entire height of the core 1 of the filter element and in particular can be permeable to fluid. In this case, such a permeability must at least have a separation efficiency exhibited by the sandwich material 2 as filter material.

The material of the circumferential casing 9 is elastically deformable in the direction perpendicular to the longitudinal axes of the flow channels 5, 6. The degree of deformability is such that the circumferential casing 9 can be used as a radial seal. Radial seal means here that the filter medium can be exchangeably inserted in a sealed manner into the circumferential edge of a channel opening of a filter device in the longitudinal direction of the flow channels 5, 6. Such a design is shown, for example, in FIG. 2 in which the channel is formed by a filter housing region 10. In this channel, the filter medium abuts tightly over the nonwoven over almost the entire length formed by the flow channels 5, 6 of the filter medium, whereby the nonwoven is compressed so that it is slightly elastically deformed. An advantage of this nonwoven seal is that this does not stick to the sealing surfaces and thus, the filter medium can easily be exchanged.

An embodiment of a filter medium according to the invention can also consist in that the circumferential casing 9 only covers an axial partial region of the total height of the filter medium whereas the other axial region can be closed in a known fashion by some cover. In this situation, this cover can be embodied as filter material in the sense of the invention.

In an embodiment of the filter medium shown in FIG. 3, the circumferential casing 9 comprises at one end of the filter medium a frame 11 connected to the core 1 of the filter medium which is provided there and which can consist of plastic, for example. This frame 11 can have a circumference which is radially necked-in. In such an embodiment, a complementary necked-in region 12 is provided in the receiving channel of the filter housing. The nonwoven of the circumferential casing 9 also completely covers the necked-in region of the frame 11. In such an embodiment the sealing of the filter medium is effected exclusively or at least predominantly in the necked-in region 12. In this embodiment also, the seal does not tend to stick to the sealing faces.

### EMBODIMENT ACCORDING TO FIGS. 4-6

A section of a flexible endless filter web material in the form of a sandwich material comprising a double-layered sandwich material as shown in FIG. 4 has a first layer 3 of relief-free endless web material, that is, a web material with virtually a smooth surface, and a second layer 4 of corrugated web material. Sections A and B alternate periodically along the filter web material. In the length sections A the individual corrugations each have the same amplitude. In the length regions B, the magnitude of the corrugation amplitude decreases continuously from an adjacent section A to a zero value, that is as far as an uncorrugated state. This uncorrugated state occupies a central region in the longitudinal direction in the length section B.

The production of an endless filter web material according to FIG. 4 will be explained hereinafter with reference to FIG. 6.

The two layers 3 and 4 of the filter web material are each unrolled from rolled starting material and then combined to form a double-layered filter web material. Before combining, the material of the second layer 2 is corrugated. These corrugations are made in a pair of embossing rollers 13. The rollers of this pair of embossing rollers 13 are each provided with intermeshing embossing profiles to produce corrugations.

In the state in which the embossing rollers 13 are shown in FIG. 6, the corrugations are embossed with constant uniform embossing amplitudes.

The axial spacing of the embossing rollers 13 is varied in order to achieve a length section B of the filter material of the second layer 4, that is after embossing a length section, this spacing is continuously enlarged until no further embossing takes place and then reduced again until a spacing of the embossing rollers 13 corresponding to the length section A is adjusted.

This production method can be carried out continuously in such a manner that endless filter web material can be achieved accordingly in double-layered form.

FIG. 5 shows a filter medium of a wound filter web material as shown in FIG. 4.

For such a filter medium in the form of a wound filter, a section L should be cut to length from the endless filter web material according to FIG. 4. Such a filter web material which has been cut to length is wound onto a core strip 14 beginning with the section B″. The exterior end forms the section B′ which consists overall of uncorrugated double-layered filter web material.

In the embodiment of a wound filter according to FIG. 5, the uncorrugated end region of the filter web material comprises a length which allows the entire outer circumference of the wound filter to be made of uncorrugated filter material. A sealing frame, for example, can be simply injection-moulded on the external circumference thus formed, this frame being merely restricted to an axial end region of the wound filter.

The separate flow channels formed from the first and second layers 3, 4 of the filter material are provided with the reference numerals 5 and 6 in FIG. 4. In this situation, for example, the flow channels 5 can be closed at one axial end of the wound filter and the flow channels 6 on the other hand can be closed at the other axial end or conversely.

In order to avoid a stepped runout of a filter web material in particular at the external circumference of a wound filter, it is sufficient in principle to let the web material run out with a length section B″.

All the features presented in the description and in the following claims can be important to the invention both individually and combined with one another in any form.

1. A filter medium comprising a plurality of adjacent tubular flow channels (5, 6) in which the flow channels (5, 6) have circumferential walls through which flow can take place, at least in part regions,
all the regions of the circumferential walls through which flow can take place consist of filter
material,
the filtration takes place inside the regions of the circumferential walls through which flow can take place, for which the flow channels (5, 6) allocated to the filtering circumferential walls are exclusively exposed to unfiltered fluid on their respectively radially one side and are exclusively exposed to filtered fluid on their radially other side,
all the flow channels (5, 6) are surrounded over at least a partial region of their length by a circumferential casing (9) with a casing surface running parallel to the longitudinal axes of the flow channels (5, 6),
the circumferential casing (9) can be designed as flow-tight or at least has regions in which transverse flow can take place as a filter material,
the casing can project over the length of the flow channels (5, 6) of the filter medium and at least in a circumferential axial partial region with reference to the axial length of the flow channels (5, 6), comprises elastic sealing material which is elastically deformable for a radial sealing function perpendicular to the casing surface,
wherein the elastic sealing material surrounded by the circumferential casing (9) consists of nonwoven.

2. The filter medium according to claim 1, wherein the elastic sealing material surrounded by the circumferential casing (9) extends over the total length of the circumferential casing (9).

3. The filter medium according to claim 1, wherein the elastic material surrounded by the circumferential casing (9) consists of web material multiply wound around the core (1) of the filter medium.

4. A flexible continuous filter web material of double-layered flow-channel-forming filter material comprising a first layer (3) having completely relief-free surfaces and a second layer (4) which is embodied as corrugated transverse to the longitudinal direction of the web, wherein the two layers (3, 4) are each joined tightly to one another in the region of the corrugation peaks of the second layer (4) facing the first layer (3), whereby flow channels (5, 6) through which longitudinal flow can take place are provided between the two webs, as starting material for a wound filter medium which can be produced by winding this web material onto one another and through which axial flow can take place, according to claim 1, wherein
the filter web material has periodically constant successive first and second length sections (A, B) with different corrugation amplitudes,
the first length section (A) exclusively has corrugations of the same amplitude,
the magnitude of the amplitudes of the corrugations varies in the second length section (B) in that this magnitude of the amplitudes diminishes continuously in each case beginning from a region adjacent to a region (A) from the magnitude in the relevant region (A) as far as 0.

5. The filter web material according to claim 4, wherein a length region (B′) in which the corrugations have no amplitude deflection within the region (B) at least corresponds to a length occupied by a double corrugation in the region (A).

6. A method for producing a filter web material according to claim 4, wherein
the two lengths (3, 4) of the filter web material are combined with one another as endless webs after the second layer (4) has been previously corrugated in a pair of embossing rollers (13),
the corrugations of the length section (A) are produced with a constant distance inside the pair of embossing rollers (13),
the axial distance inside the pair of embossing rollers (13) is varied accordingly during the embossing of this length section to produce the corrugations in the length section (B).

7. A filter medium in the form of wound filter of filter web material according to claim 4, wherein at least one of the two web ends is formed as a region (B) of the web material.

8. The filter medium in the form of a wound filter according to claim 6, wherein on the outer circumference of the wound filter, the web end which runs out there as region (B) surrounds the entire outer circumference at least once.

9. The wound filter according to claim 8, wherein in the web material surrounding the outer circumference of the wound filter as region (B), the second layer (4) is provided without any corrugation as a region (B′) apart from a narrow transition region in which the amplitudes of the formed corrugations diminish continuously.

10. A filter medium in the form of a wound filter with a combination of features according to claim 1.
